(19) United States
(12) Patent Application Publication
(10) Pub. No.: US 2026/0269675 A1
(43) Pub. Date: Sep. 10, 2026

(54) MOTOR DRIVE DEVICE

(71) Applicant: FANUC CORPORATION, Yamanashi (JP)

(72) Inventor: Kazuhiro Yamamoto, Yamanashi (JP)

(21) Appl. No.: 19/164,304

(22) PCT Filed: May 11, 2023
(86) PCT No.: PCT/JP2023/017755

§ 371 Date: Sep. 11, 2025

(51) Int. Cl. H02K 5/08; H02K 11/33

(52) U.S. Cl. CPC H02K 5/08; H02K 11/33; H02K 2211/03

(57) ABSTRACT

Provided is a motor drive device comprising a housing that is less likely to warp during shrinkage. This motor drive device has: a housing of which at least one surface is composed of a molded article; and an electronic component disposed inside the housing. The molded article has at least one slit for reducing warpage during molding and shrinkage.

### CROSS-REFERENCE TO RELATED APPLICATIONS

This application is a National Stage application of International Application No. PCT/JP2023/017755 filed May 11, 2023.

### BACKGROUND

### Field

The present disclosure relates to a motor drive device.

### Discussion of the Related Art

A motor drive device is known as a device for driving a motor used for applications such as driving each axis of a machine tool or a robot. A typical motor drive device includes electronic components such as a power element and a capacitor for supplying current to the motor, with these electronic components being arranged in a housing.

The housing is, for example, a molded article manufactured by resin molding, and has a generally rectangular parallelepiped shape. Also, the housing may have a cutout or an opening for arranging the electronic components, etc.

The molded article such as resins used as the housing for the motor drive device may shrink at a certain rate after being molded. When this happens, the molded article, especially when it is thin, may warp due to shrinkage, which can cause problems such as poor assembly and interference with other components.

Therefore, there is a need for a motor drive device having a housing which is less likely to warp when it shrinks.

### SUMMARY

One aspect of the present disclosure provides a motor drive device including a housing having at least one surface composed of a molded article; and an electronic component arranged in the housing, wherein the molded article has at least one slit configured to reduce warpage during molding and shrinkage.

### BRIEF DESCRIPTION OF DRAWINGS

FIG. 1 is a perspective of a motor drive device according to an embodiment.

FIG. 2 is a schematic perspective view of a housing according to a first example.

FIG. 3 is a schematic perspective view of a housing according to a second example.

FIG. 4 is a schematic perspective view of a housing according to a third example.

FIG. 5 is a schematic perspective view of a housing according to a fourth example.

FIG. 6 is a schematic perspective view of a housing according to a fifth example.

FIG. 7 is a schematic perspective view of a housing according to a sixth example.

FIG. 8 is a perspective view showing an example in which a flange and a PCB are attached to the housing according to the sixth example.

FIG. 9 is a perspective view of a combination of housings according to a seventh example.

FIG. 10 is a perspective view of a combination of housings according to an eighth example.

FIG. 11 is a perspective view of a housing according to a first comparative example.

FIG. 12 is a view showing an example or warping of the housing of FIG. 11.

FIG. 13 is a perspective view of a housing according to a second comparative example.

FIG. 14 is a view showing an example or warping of the housing of FIG. 13.

FIG. 15 is a perspective view of a housing according to a third comparative example.

FIG. 16 is a view showing an example or warping of the housing of FIG. 15.

### DESCRIPTION OF EMBODIMENTS

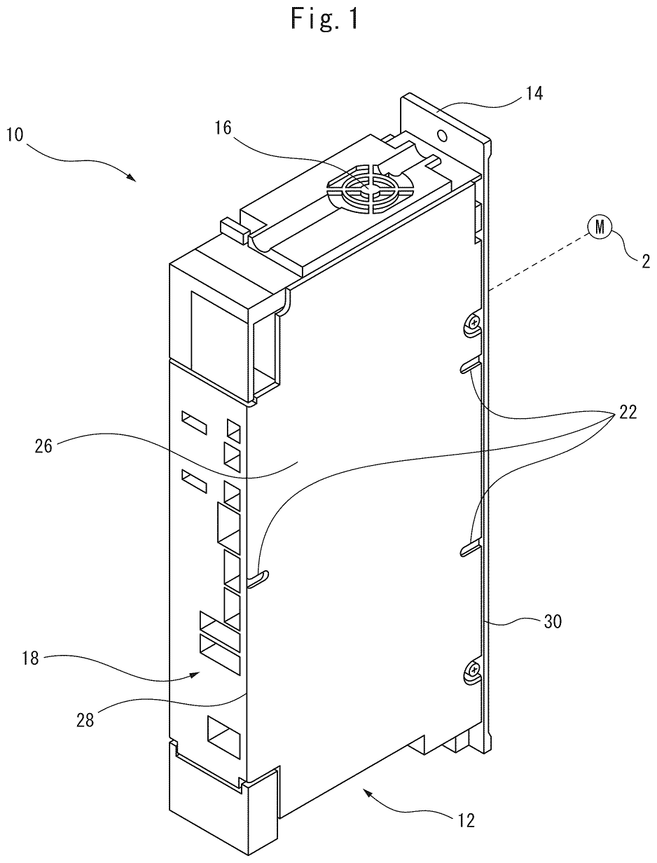

FIG. 1 is a perspective showing a schematic configuration of a motor drive device 10 according to a preferred embodiment. The motor drive device The motor drive device 10 is a device for driving a schematically shown motor 2, and has a generally rectangular parallelepiped shape as a whole. The motor drive device 10 has a housing 12, and a printed circuit board (described later) provided inside the housing 12 and on which an electronic component such as a drive circuit component are mounted. The motor drive device 10 optionally has a flange 14, a cooling fan 16, and at least one connector 18 to which a cable, etc., (not shown) for supplying power and communicating a signal can be detachably attached to the motor drive device 10. The motor 2 is, for example, a motor such as a servomotor configured to drive each axis of a machine tool or a robot, and the drive circuit component is, for example, a power element described later.

At least one surface of the housing 12 is composed of a molded article, and in the illustrated example, a surface 26 of the housing 12 is a molded article. Herein, the molded article means a manufactured product having a material which shrinks at a certain rate after being molded, and is typically a resin product formed by injection molding, etc. The surface 26 also has at least one slit 22 configured to reduce warping which may occur in the molded article when it shrinks.

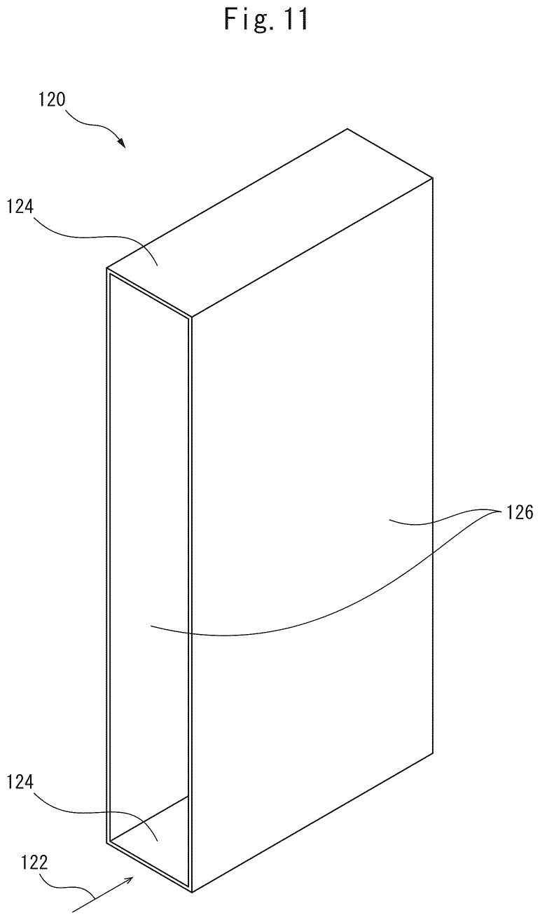

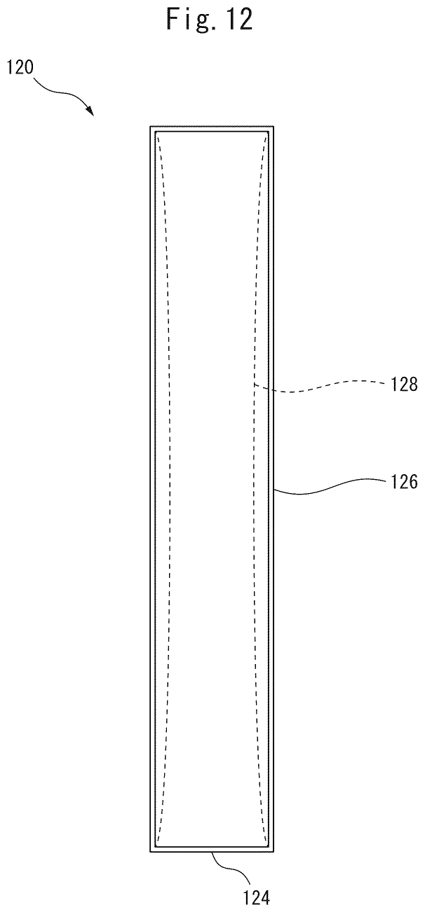

FIGS. 11 to 16 show structural examples of a housing according to comparative examples. FIG. 11 is a perspective view of a housing 120 which can be used for a motor drive device having a substantially rectangular parallelepiped shape, and FIG. 12 is a view of the housing 120 as viewed in the direction of an arrow 122.

The housing 120 is a box-shaped molded article having four of six faces constituting the rectangular parallelepiped, and has a pair of parallel flat surfaces 124 and a pair of flat surfaces 126 larger than the flat surfaces 124. When the housing 120 shrinks after being molded, the flat surfaces 126 tend to warp inward, as shown by a dashed line 128 in FIG. 12. Therefore, the housing 120 does not have the desired shape, which not only deteriorates assembly, but also may interfere with electronic components, etc., disposed inside the housing 120.

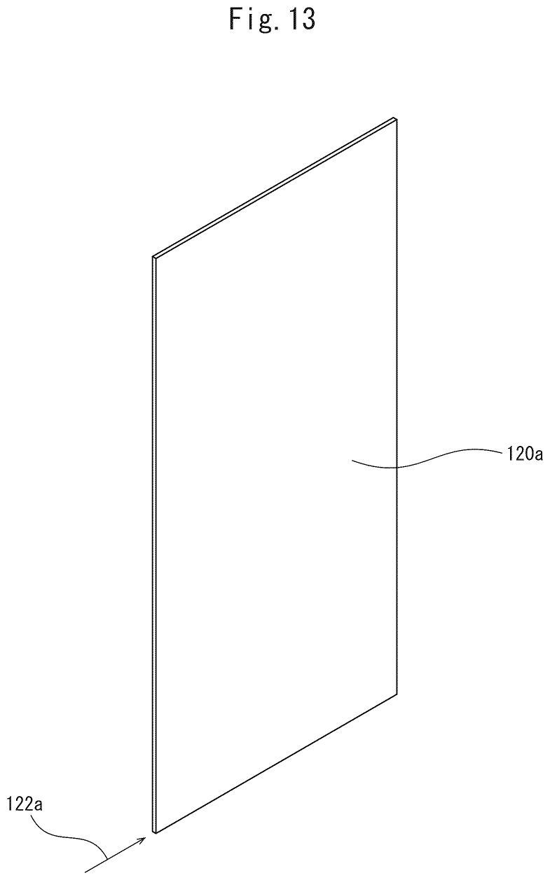

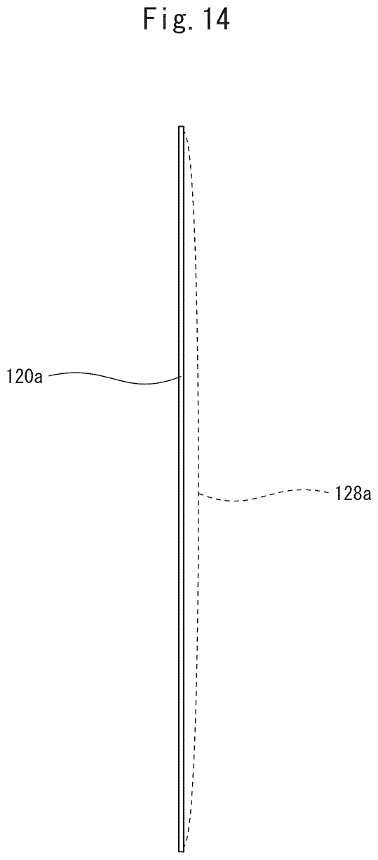

FIG. 13 is a perspective view of a housing 120a which can be used in the motor drive device having the substantially rectangular parallelepiped shape, and FIG. 14 is a view of the housing 120a as viewed in the direction of an arrow 122a. The housing 120a is a molded article having the shape of a flat plate which corresponds to one surface of the rectangular parallelepiped. When the housing 120a shrinks after being molded, the housing 120a tends to bend as shown by a dashed line 128a in FIG. 14. Therefore, the housing 120a does not have the desired shape, which not only deteriorates assembly, but also may interfere with electronic components, etc., disposed inside the housing 120a.

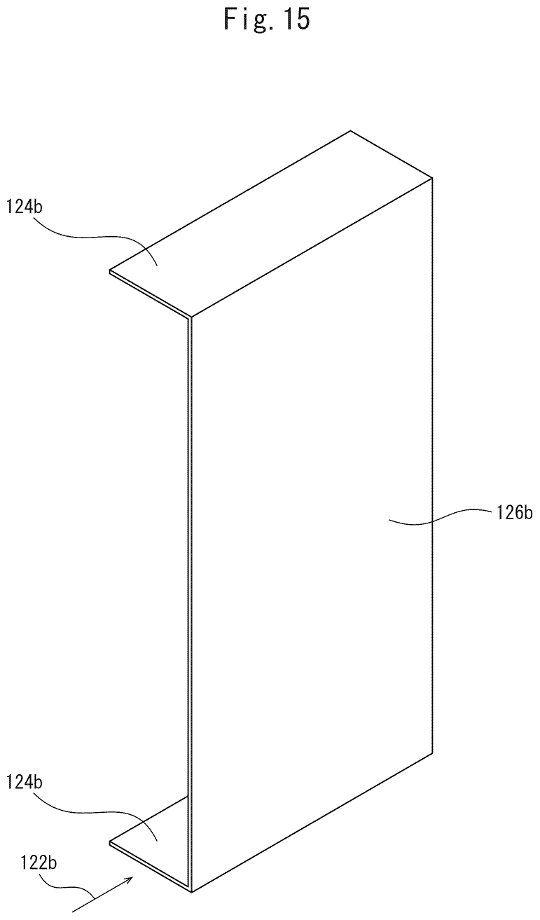

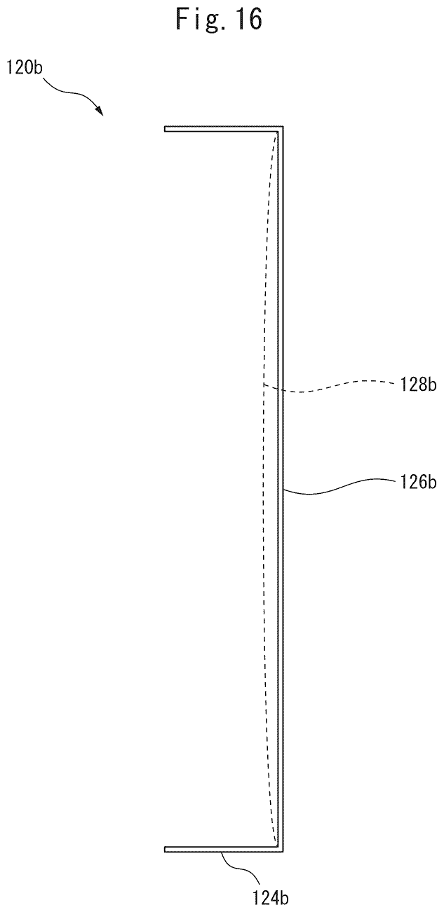

FIG. 15 is a perspective view of a housing 120b which can be used in the motor drive device having the substantially rectangular parallelepiped shape, and FIG. 16 is a view of the housing 120b as viewed in the direction of an arrow 122b. The housing 120b is a molded article having three of six faces constituting the rectangular parallelepiped, and is generally U-shaped in side view, with a pair of parallel flat surfaces 124b and one flat surface 126b larger than flat surfaces 124b. When the housing 120b shrinks after being molded, the flat surface 126b tends to warp inward, as shown by a dashed line 128b in FIG. 16. Therefore, the housing 120b does not have the desired shape, which not only deteriorates assembly, but also may interfere with electronic components, etc., disposed inside the housing 120b.

As described above, in all of the comparative examples, warping due to shrinkage of the molded article may cause problems such as poor assembly of the motor drive device and interference between the housing and other components. Therefore, hereinafter, working examples of housings provided with means for solving these problems will be described.

### First Example

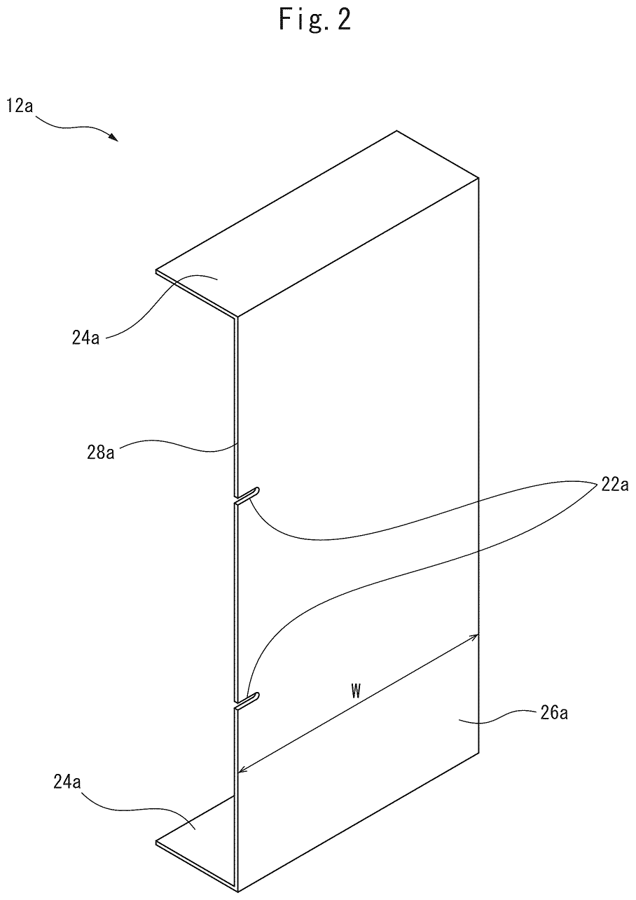

FIG. 2 shows a housing 12a according to the first example. The housing 12a is a molded article having three of six surfaces constituting a rectangular parallelepiped, and is generally U-shaped in a side view. The housing 12a has a pair of parallel flat surfaces 24a and one flat surface 26a larger than each of the flat surfaces 24a. The surface 26a has at least one (two in the illustrated example) 22a configured to reduce warping which may occur during shrinkage of the molded article.

Each slit 22a extends from at least one side (here, a long side 28a) of the surface 26a in a direction generally perpendicular to the side 28a. By forming the slit 22a at the side 28a, deformation of the side 28a during molding shrinkage of the housing 12a is reduced, and as a result, warping of the housing 12a can be reduced.

The slit 22a in this example is for reducing warpage during molding shrinkage of the housing 12a, and are not for attaching or inserting other members. Therefore, it is preferable that the slit 22a be formed at a portion which is not close to other components in the housing 12a. Further, the slit 22a may have a relatively small size, and for example, the length of each slit 22a approximately perpendicular to the side 28a is 5 mm or less, 10 mm or less, or 20 mm or less. Alternatively, the length of each slit 22a may be defined as a ratio to a width W of the surface 26a on which the slit 22a is formed, which is parallel to the length of the slit 22a, and for example, the length of the slit 22a is 5% or less, 10% or less, or 20% or less of the width W.

On the other hand, the width perpendicular to the length of each slit 22a is, for example, 1 mm or less, 3 mm or less, or 5 mm or less. The slits 22a may also be defined by an opening area of the slit 22a relative to the area of the surface 26a, for example, the opening area of the slit 22a (roughly width×length×number) being 10% or less, 5% or less, or 3% or less of the area of the surface 26a.

### Second Example

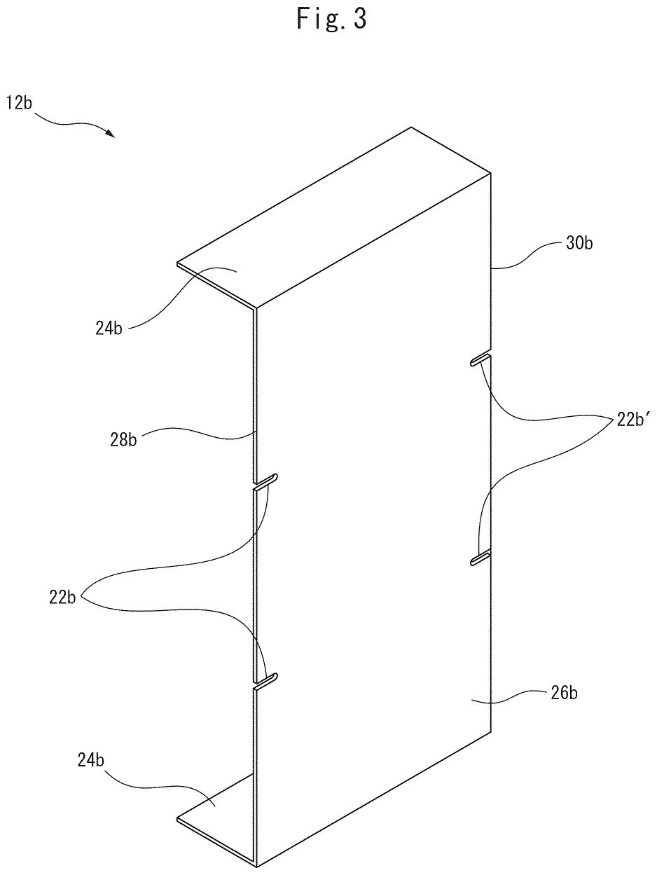

FIG. 3 shows a housing 12b according to the second example. The housing 12b is a molded article having three of six surfaces constituting a rectangular parallelepiped, and is substantially U-shaped in a side view. The housing 12b has a pair of parallel flat surfaces 24b and one flat surface 26b larger than each of the flat surfaces 24b. The surface 26b has a plurality of (four in the illustrated example) slits 22b, 22b′ configured to reduce warping which may occur during shrinkage in the molded article.

The slits 22b extend from one side (a long side 28b in this example) of the surface 26b in a direction substantially perpendicular to the side 28b. On the other hand, the slits 22b′ extend from a long side 30b opposed to the side 28b in a direction substantially perpendicular to the side 30b. By forming the slits 22b, 22b′ on the two parallel sides of the surface 26b in this way, deformation of the sides 28b, 30b during molding shrinkage of the housing 12b is reduced, and as a result, warping of the housing 12b can be reduced.

In the second example, the position of the slit 22b in the longitudinal direction of the side 28b is equal to the position of the slit 22b′ in the longitudinal direction of the side 30b, in other words, the slits 22b and 22b′ are formed symmetrically with respect to a center line parallel to the long side 28b or 30b of the surface 26b. The dimensions of the slits 22b and 22b′ may be the same as those in the first example, and thus explanations thereof will be omitted.

### Third Example

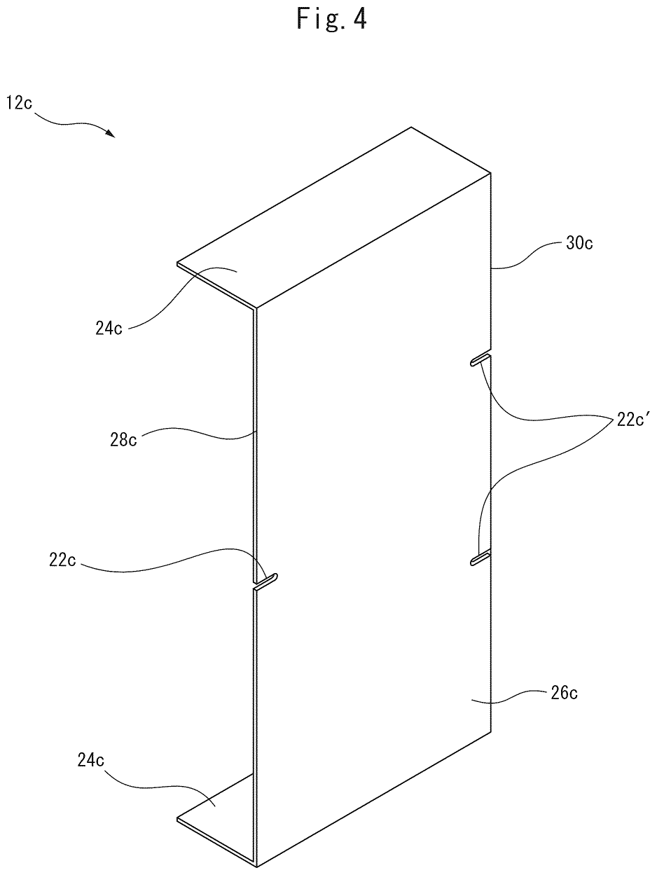

FIG. 4 shows a housing 12c according to the third example. The housing 12c is a molded article having three of six surfaces constituting a rectangular parallelepiped, and is generally U-shaped in a side view, with a pair of parallel flat surfaces 24c and one flat surface 26c larger than each of the flat surfaces 24c. The surface 26c has a plurality of (three in the illustrated example) slits 22c, 22c′ configured to reduce warpage which may occur in the molded article during shrinkage.

One slit 22c extends from one long side 28c of the surface 26c in a direction substantially perpendicular to the side 28c. On the other hand, two slits 22c′ extend from a long side 30c parallel to the side 28c in a direction substantially perpendicular to the side 30c. In the third example, the position of the slit 22c in the length direction of the side 28c and the position of the slit 22c′ in the length direction of the side 30c are different from each other, in other words, the slits 22c and 22c′ are asymmetrically arranged with respect to the center line parallel to the long side 28c or 30c of the surface 26c. By forming the slits 22c and 22c′ on the two parallel sides of the surface 26c in this way, the deformation of the sides 28c and 30c during molding shrinkage of the housing 12c is reduced, and as a result, the warping of the housing 12c can be reduced. Further, since the slits 22c and 22c′ are not symmetrical, the decrease in the rigidity of the housing 12c can also be suppressed. The dimensions of the slits 22c, 22c′ may be the same as those in the first example, and thus explanations thereof will be omitted.

### Fourth Example

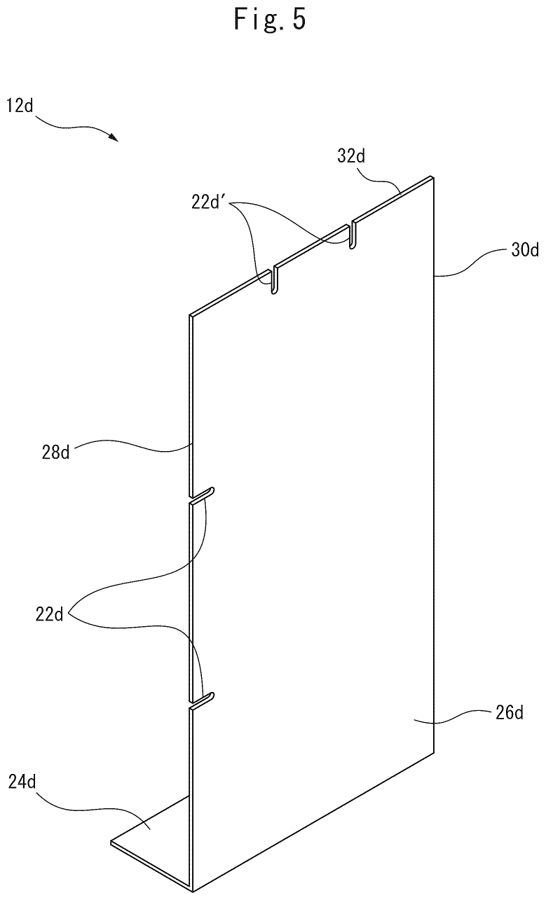

FIG. 5 shows a housing 12d according to the fourth example. The housing 12d is a molded article having two of six surfaces constituting a rectangular parallelepiped, and has a substantially L-shaped shape in a side view. The housing 12d has a flat surface 24d and a flat surface 26d larger than the surface 24d and is connected perpendicular to the surface 24d.

The surface 26d has a plurality of (four in the illustrated example) slits 22d, 22d′ configured to reduce warping which may occur during shrinkage in the molded article. Specifically, the two slits 22d extend from one long side 28d of the surface 26d in a direction substantially perpendicular to the side 28d. On the other hand, the two slits 22d′ extend from a short side 32d perpendicular to the side 28d in a direction substantially perpendicular to the side 32d. By forming the plurality of slits extending in different directions on the surface 26d in this way, it is possible to reduce warping of the housing 12d during molding shrinkage not only in one direction but also in multiple directions. The dimensions of the slits 22d, 22d′ may be the same as those in the first example, and thus explanations thereof will be omitted.

### Fifth Example

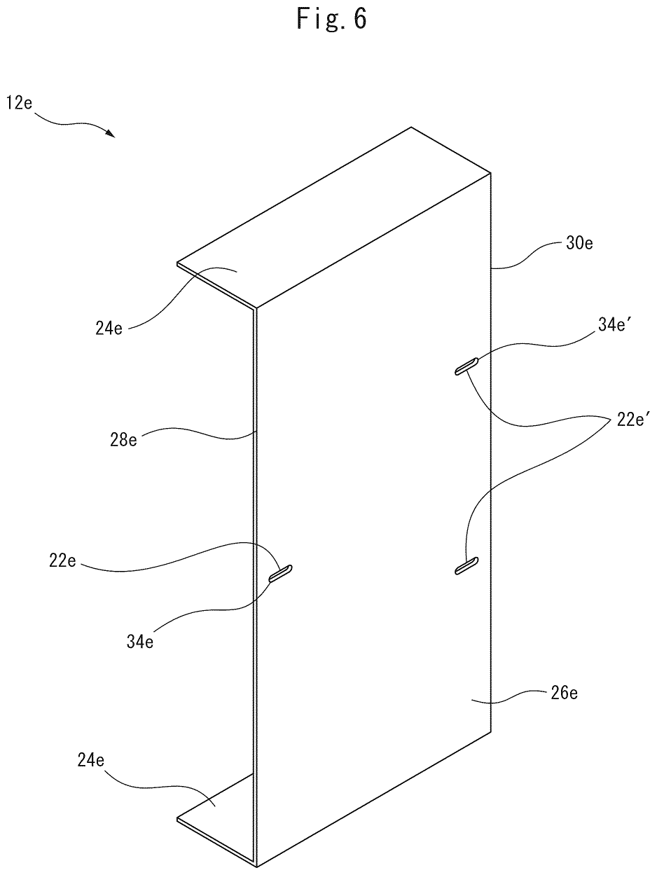

FIG. 6 shows a housing 12e according to the fifth example. The housing 12e is a molded article having three of six surfaces constituting a rectangular parallelepiped, and is generally U-shaped in a side view. The housing 12e has a pair of parallel flat surfaces 24e and one flat surface 26e larger than each of the flat surfaces 24e. The surface 26e has a plurality of (three in the illustrated example) slits 22e, 22e′ configured to reduce warping which may occur in the molded article during shrinkage.

The fifth example is similar to the third example, but the slit 22e is not opened on a long side 28e of the surface 26e, and the shortest distance between an end 34e of the slit 22e closest to the side 28e and the side 28e is, for example, 5 mm or less, 3 mm or less, or 1 mm or less. Similarly, the slits 22e′ are not opened at a long side 30e of the surface 26e, and for example, the shortest distance between an end 34e′ of the slit 22e′ closest to the side 30e and the side 30e is 5 mm or less, 3 mm or less, or 1 mm or less.

In this way, by forming the slits on the surface 26e which are not opened on each side, it is possible to reduce warping of the housing 12e when molding shrinkage to a certain extent. The fifth example is inferior to the third example in terms of the effect of reducing warping, but it is possible to suppress the decrease in rigidity of the housing 12e to a greater extent than the third example. The dimensions of the slits 22e, 22e′ may be the same as those of the first example, and thus explanations thereof will be omitted.

### Sixth Example

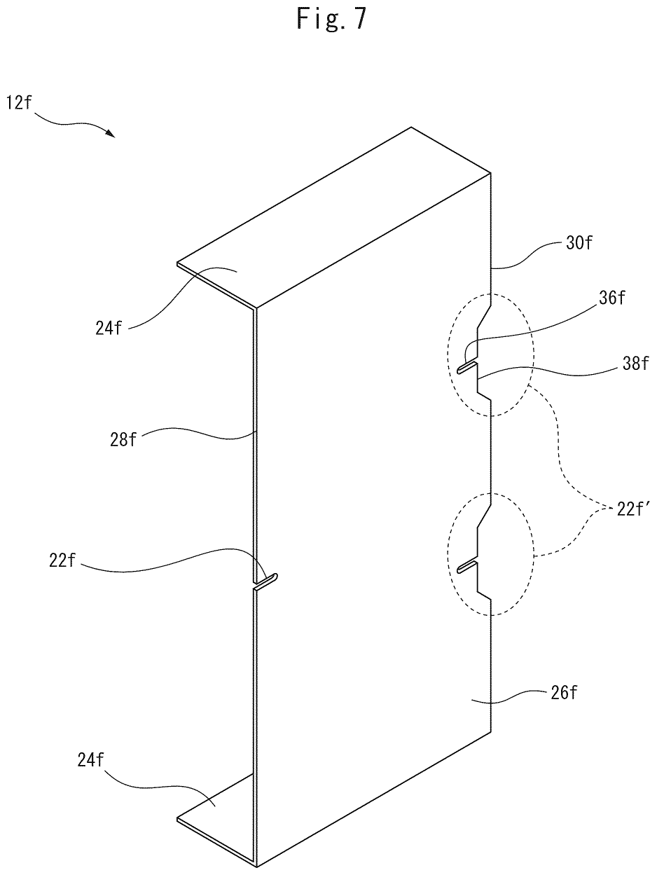

FIG. 7 shows a housing 12f according to the sixth example. The housing 12f is a molded article having three of six surfaces constituting a rectangular parallelepiped, and is generally U-shaped in a side view. The housing 12f has a pair of parallel flat surfaces 24f and one flat surface 26f larger than each of the flat surfaces 24f. The surface 26f has a plurality of (three in the illustrated example) slits 22f, 36f configured to reduce warping which may occur in the molded article during shrinkage.

In the sixth example, one slit 22f is formed in a long side 28f, and the shape and dimension of the slit 22f may be the same as those of the slit 22c in the third example. On the other hand, the slit 36f provided at a long side 30f is formed as a part of a cutout 22f.

The cutout 22f has a recess 38f provided in the vicinity of the power element described below and the slit 36f which is opened into the recess 38f. The cutout 22f has a function of allowing a blast of the power element to escape and a function of reducing warping of the housing 12f.

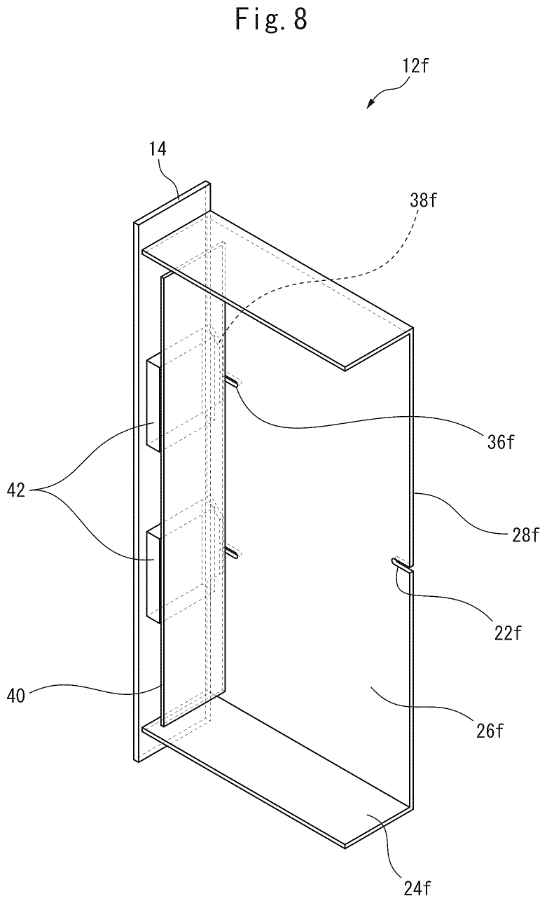

As shown in FIG. 8, a printed circuit board (PCB) 40 is arranged in the housing 12f, and at least one (two in the illustrated example) power element 42 is mounted on the PCB 40. The housing 12f also has a flange 14 for mounting the housing 12f to another member, and the flange 14 also has a function of covering and protecting the power element 42. The recess 38f described above is formed so that the side part of the power element 42 adjacent to the surface 26f is exposed.

Although it is extremely rare, the power element 42 may explode due to a short circuit, etc., and in that case, a blast may be generated. If the power element 42 is surrounded by other components, or if the motor drive device has a housing structure which makes it difficult for the blast to escape to the outside, the blast may damage or fall off the housing or other components inside the housing. However, as in the sixth example, by forming the recess 38f adjacent to the power element 42 in the housing 12f, the blast can be suitably released from the recess 38f, and the housing and other components can be prevented from being damaged or dropping. Further, since the cutout 22f′ has the slit 36f in addition to the recess 38f, the cutout 22f also has the function of reducing warping of the side 30f during molding shrinkage.

### Seventh Example

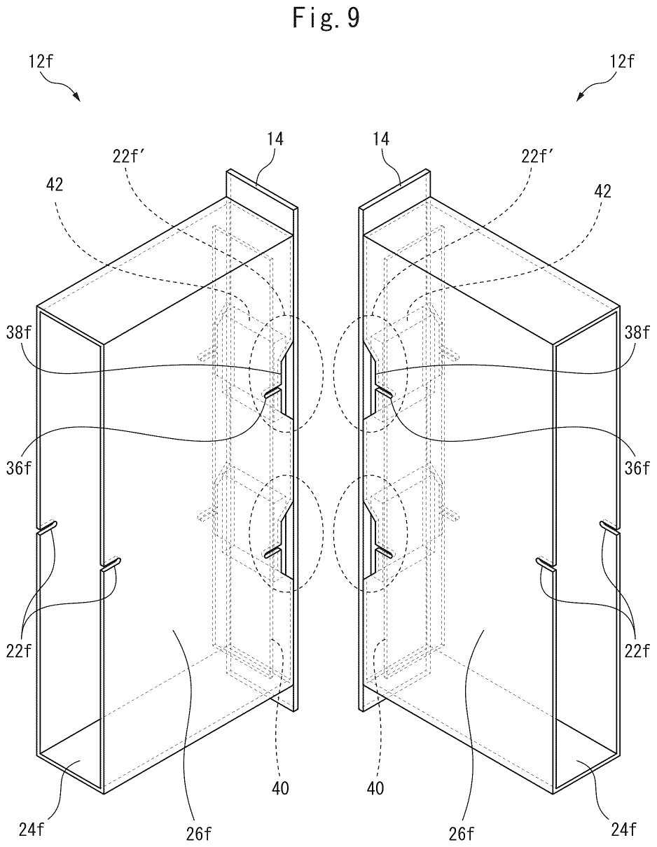

FIG. 9 shows a combination of housings according to the seventh example. The seventh example corresponds to an arrangement of a plurality of (two in the illustrated example) the housings 12f according to the sixth example. Specifically, the two housings 12f are arranged so that their recesses 38f face each other closely. In other words, in the seventh example, the recesses 38f of one housing 12f are arranged at substantially the same position as the recesses 38f of the other housing 12f, so that even when the power element 42 of one housing 12f explodes and a blast is generated, the blast can easily escape to the outside through the two adjacent recesses 38f.

### Eighth Example

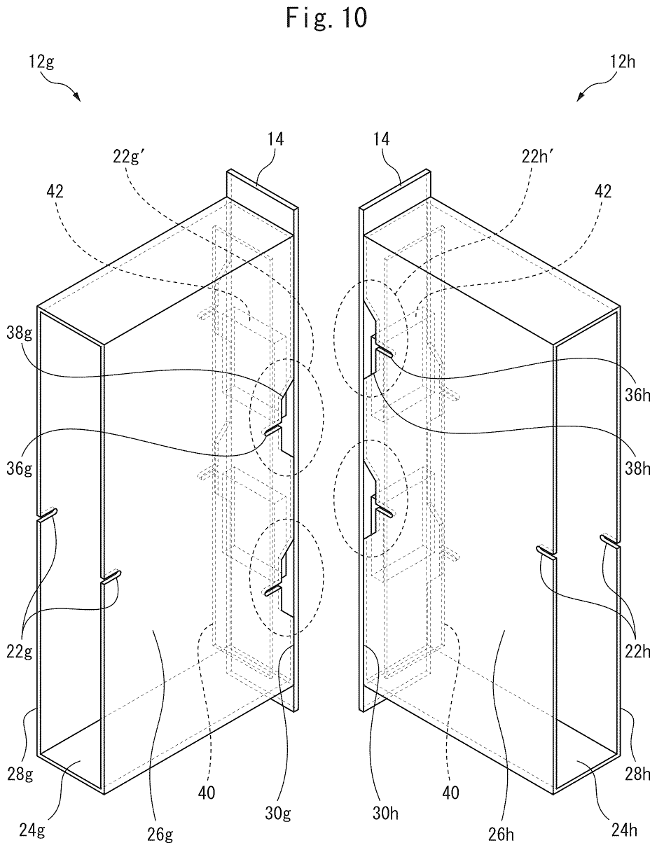

FIG. 10 shows a combination of housings according to the eighth example. The eighth example corresponds to an arrangement of a plurality of housings, and in the illustrated example, has two housings (here, a first housing 12g and a second housing 12h) arranged close to each other. The housing 12g is a molded article having a substantially box-like shape with four of six surfaces constituting a rectangular parallelepiped, and has a pair of parallel flat surfaces 24g and a pair of parallel flat surfaces 26g each larger than each of the flat faces 24g. Each of the surfaces 26g has a plurality of (four in the illustrated example) slits 22g, 36g configured to reduce warping which may occur in the molded article during shrinkage.

One slit 22g is formed at a long side 28g of the first housing 12g, and the shape and dimension of the slit 22g may be the same as those of the slit 22c in the third example. On the other hand, the slit 36g provided at the long side 30g is formed as a part of the cutout 22g′.

The cutout 22g′ has a recess 38g provided in the vicinity of the power element 42 and a slit 36g which is opened into the recess 38g. The cutout 22g′ has a function of escaping the blast of the power element 42 and a function of reducing warping of the housing 12g.

A printed circuit board (PCB) 40 is arranged in the housing 12g, and at least one (two in the illustrated example) power element 42 is mounted on the PCB 40. The housing 12g also has a flange 14 for attaching the housing 12g to another member, and the flange 14 also has a function of covering and protecting the power element 42. The recess 38g as described above has approximately the same area as the side part of the power element 42 adjacent to the surface 26g, and is formed at a position shifted by a predetermined distance from the power element 42 so that the side part of the power element 42 is partially exposed.

The second housing 12h has a structure similar to that of the housing 12g, except for the position of the cutout 22h′. Therefore, the components of the housing 12h other than the cutout 22h′ are given reference numerals with the suffixes changed from g to h compared to the reference numerals of the corresponding components of the housing 12g, and detailed explanations thereof will be omitted.

Although the recess 38h of the housing 12h is also formed so that the side part of the power element 42 adjacent to the surface 26h is partially exposed, the direction of displacement relative to the power element 42 is opposite to that of the recess 38g of the housing 12g. Therefore, the recess 38g and the recess 38h are not in a mutually opposing positional relationship. Therefore, in the eighth example, in addition to being able to release a certain amount of the blast caused by the explosion of the power element 42 of one housing to the outside, the blast is less likely to enter the other housing. Therefore, fragments contained in the blast are also less likely to enter the other housing, and secondary disasters such as damage to components in the other housing due to the fragments can be prevented.

The examples as described above may be combined as appropriate. For example, the slit 22b in the second example may be replaced with the slit 22e in the fifth example.

Although the present disclosure has been described in detail, the present disclosure is not limited to the above-mentioned individual embodiments. Various additions, replacements, modifications, partial deletions, etc. are possible for these embodiments within the scope of the gist of the present disclosure, or within the scope of the gist of the present disclosure derived from the contents described in the claims and their equivalents. These embodiments can also be implemented in combination. For example, in the above-mentioned embodiments, the order of each operation and the order of each process are shown as examples, and are not limited to these. The same applies when numerical values or formulas are used in the description of the above-mentioned embodiments.

The following supplementary clauses are further disclosed regarding the above-described embodiment and modified examples.

### Clause 1

A motor drive device comprising: a housing having at least one surface composed of a molded article; and an electronic component arranged in the housing, wherein the molded article has at least one slit configured to reduce warpage during molding and shrinkage.

### Clause 2

The motor drive device according to clause 1, wherein the slit extends from at least one side of the molded article.

### Clause 3

The motor drive device according to clause 2, wherein the slit is formed on each of sides of the molded article opposed to each other.

### Clause 4

The motor drive device according to clause 3, wherein the slits are asymmetrically arranged with respect to a center line parallel to the opposing sides of the molded article.

### Clause 5

The motor drive device according to clause 2, wherein the slits extend in different directions on the molded article.

### Clause 6

The motor drive device according to clause 1, wherein the slit is not opened at the side of the molded article, and the shortest distance between an end of the slit closest to the side and the side is 5 mm or less.

### Clause 7

The motor drive device according to clause 1, wherein the electronic component includes a power element, the molded article has a recess provided in the vicinity of the power element, and the slit is opened into the recess.

### Clause 8

The motor drive device according to clause 7, wherein the motor drive device includes a plurality of the housings, and the housings are arranged so that the recesses of the housings are closely opposed to each other.

### Clause 9

The motor drive device according to clause 7, wherein the motor drive device includes a plurality of the housings, and the recess of a first housing among the plurality of housings is formed at a position shifted a predetermined distance from the power element so that the power element in the first housing is partially exposed, and the recess of a second housing among the plurality of housings is formed at a position shifted a predetermined distance in the opposite direction from the power element to the first housing so that the power element in the second housing is partially exposed.

### Clause 10

The motor drive device according to clause 1, wherein a length of the slit is 20 mm or less, and a width of the slit perpendicular to the length is 5 mm or less.

### Clause 11

The motor drive device according to clause 1, wherein a length of the slit is 20% or less of a width of the molded article parallel to the length of the slit formed in the molded article.

### Clause 12

The motor drive device according to clause 1, wherein an opening area of the slit is 10% or less of an area of the molded article in which the slit is formed.

### REFERENCE SIGNS LIST

2 motor
10 motor drive device
12, 12a-12h housing
14 flange
22, 22a-22h, 36f-36h slit
24a-24h, 26, 26a-26h surface
38f-38h recess
40 PCB
42 power element

1. A motor drive device comprising:
a housing having at least one surface composed of a molded article; and
an electronic component arranged in the housing,
wherein the molded article has at least one slit configured to reduce warpage during molding and shrinkage.

2. The motor drive device according to claim 1, wherein the slit extends from at least one side of the molded article.

3. The motor drive device according to claim 2, wherein the slit is formed on each of sides of the molded article opposed to each other.

4. The motor drive device according to claim 3, wherein the slits are asymmetrically arranged with respect to a center line parallel to the opposing sides of the molded article.

5. The motor drive device according to claim 2, wherein the slits extend in different directions on the molded article.

6. The motor drive device according to claim 1, wherein the slit is not opened at the side of the molded article, and the shortest distance between an end of the slit closest to the side and the side is 5 mm or less.

7. The motor drive device according to claim 1, wherein the electronic component includes a power element, the molded article has a recess provided in the vicinity of the power element, and the slit is opened into the recess.

8. The motor drive device according to claim 7, wherein the motor drive device includes a plurality of the housings, and the housings are arranged so that the recesses of the housings are closely opposed to each other.

9. The motor drive device according to claim 7, wherein the motor drive device includes a plurality of the housings, and the recess of a first housing among the plurality of housings is formed at a position shifted a predetermined distance from the power element so that the power element in the first housing is partially exposed, and the recess of a second housing among the plurality of housings is formed at a position shifted a predetermined distance in the opposite direction from the power element to the first housing so that the power element in the second housing is partially exposed.

10. The motor drive device according to claim 1, wherein a length of the slit is 20 mm or less, and a width of the slit perpendicular to the length is 5 mm or less.

11. The motor drive device according to claim 1, wherein a length of the slit is 20% or less of a width of the molded article parallel to the length of the slit formed in the molded article.

12. The motor drive device according to claim 1, wherein an opening area of the slit is 10% or less of an area of the molded article in which the slit is formed.
